(19) United States
(12) Patent Application Publication
(10) Pub. No.: US 2024/0247139 A1
(43) Pub. Date: Jul. 25, 2024

(54) SOLID COMPOSITION AND METHOD FOR PRODUCING THE SAME

(71) Applicant: Sumitomo Chemical Company, Limited, Chuo-ku, Tokyo (JP)

(72) Inventor: Shunsuke CHIBA, Ichihara-shi, Chiba (JP)

(21) Appl. No.: 18/030,270

(22) PCT Filed: Sep. 29, 2021
(86) PCT No.: PCT/JP2021/035866

§ 371 Date: Nov. 29, 2023

(30) Foreign Application Priority Data
Oct. 7, 2020 (JP) 2020-169761

(51) Int. Cl. C08L 23/12

(52) U.S. Cl. CPC C08L 23/12; C08L 2205/025

(57) ABSTRACT

A solid composition contains a propylene-based polymer B and a polymer A, and satisfies the following requirements (1) to (3).

Requirement (1): the propylene-based polymer B forms a continuous phase, and the polymer A forms a dispersed phase.

Requirement (2): the polymer A has a glass transition temperature (Tg) of lower than 0° C.

Requirement (3): a crystal orientation degree of the solid composition represented by the following formula is 60 to 80%.

$$Crystal orientation degree ( \% ) = \{ ( 180 - hw 040 ) / 180 \} \times 100 \qquad ( 1 )$$

In formula (1), hw040 represents a half-value width (degree) of a maximum peak in a distribution curve of scattering intensity of a (040) plane of an α crystal of the propylene-based polymer with respect to an azimuth angle, obtained from a two-dimensional wide-angle X-ray scattering image of a central portion of the solid composition.

### TECHNICAL FIELD

The present invention relates to a solid composition and a method for producing the same.

### BACKGROUND ART

Conventionally, a solid composition obtained by molding a resin composition containing a propylene-based polymer has been used for automobile parts and home electric appliance parts. Such a solid composition contains not only the propylene-based polymer but also a copolymer of ethylene and an α-olefin having 3 or more carbon atoms, an inorganic filler, and the like.

For example, Patent Document 1 describes a resin composition containing an isotactic propylene-based polymer and a propylene-ethylene-α-olefin copolymer containing a structural unit derived from propylene in an amount of 84 to 50 mol %, containing a structural unit derived from ethylene in an amount of 15 to 30 mol %, further containing a structural unit derived from an α-olefin having 4 to 20 carbon atoms in an amount of 1 to 20 mol %, having an isotactic triad fraction (mm) of 85% or more as calculated by 13C-NMR, and having no melting point observed by DSC.

### PRIOR ART DOCUMENT

### Patent Document

Patent Document 1: JP-B2-5020524

### SUMMARY OF THE INVENTION

### Problems to be Solved by the Invention

By the way, it is required to further improve impact resistance at a low temperature in a solid composition mainly containing a propylene-based polymer.

The present invention has been made in view of the above problem, and an object of the present invention is to provide a solid composition excellent in impact resistance at a low temperature and a method for producing the same.

### Means for Solving the Problems

A solid composition according to the present invention is a solid composition containing a propylene-based polymer B and a polymer A, and satisfies the following requirements (1) to (3).

Requirement (1): the propylene-based polymer B forms a continuous phase, and the polymer A forms a dispersed phase.

Requirement (2): the polymer A has a glass transition temperature (Tg) of lower than 0° C.

Requirement (3): a crystal orientation degree of the solid composition represented by the following formula is 60 to 80%.

$$Crystal orientation degree ( \% ) = \{ ( 180 ‐ h w 0 \; 40 ) / 180 \} \times 100 \qquad ( 1 )$$

[In formula (1), hw040 represents a half-value width (degree) of a maximum peak in a distribution curve of scattering intensity of a (040) plane of an α crystal of the propylene-based polymer B with respect to an azimuth angle, obtained from a two-dimensional wide-angle X-ray scattering image of a central portion of the solid composition. ]

Here, when the total of the propylene-based polymer B and the polymer A is 100 parts by weight, the propylene-based polymer B can occupy 50.1 to 99.9 parts by weight, and the polymer A can occupy 0.1 to 49.9 parts by weight.

In addition, the polymer A can have a glass transition temperature (Tg) of −30° C. or lower.

The polymer A can be an ethylene-based copolymer.

In addition, the ethylene-based copolymer can be at least one selected from the group consisting of an ethylene-propylene copolymer, an ethylene-1-butene copolymer, and an ethylene-1-octene copolymer.

In addition, in the solid composition, the polymer A can have a melt mass flow rate of 0.01 to 35 g/10 min under conditions of a temperature of 190° C. and a load of 2.16 kgf.

A method for producing a solid composition according to the present invention includes a step of causing a solid raw material containing a thermoplastic resin and the polymer A to flow under pressure at a temperature of a melting point (° C.) of the thermoplastic resin +10° C. or lower to obtain a solid composition, in which
in the solid composition, the thermoplastic resin forms a continuous phase, and the polymer A forms a dispersed phase,
the polymer A has a glass transition temperature (Tg) of lower than 0° ° C., and
a crystal orientation degree represented by the following formula in the solid composition is 60 to 80%.

$$Crystal orientation degree ( \% ) = \{ ( 180 ‐ h w 0 \; 40 ) / 180 \} \times 100 \qquad ( 1 )$$

[In formula (1), hw040 represents a half-value width (degree) of a maximum peak in a distribution curve of scattering intensity at a scattering angle 2θ′ with respect to an azimuth angle β, obtained from a two-dimensional wide-angle X-ray scattering image of a central portion of the solid composition, and the scattering angle 2θ′ is an angle that gives a maximum peak within a range of a scattering angle 2θ=16° to 18°.]

### Effect of the Invention

The present invention provides a solid composition excellent in impact resistance at a low temperature and a method for producing the same.

### BRIEF DESCRIPTION OF THE DRAWINGS

FIGS. 1(a) and 1(b) are schematic diagrams sequentially describing a method for producing a solid composition according to an embodiment of the present invention, FIG. 1(c) is a side view of a solid composition obtained, and FIG. 1(d) is a top view of the solid composition obtained.

### MODE FOR CARRYING OUT THE INVENTION

Hereinafter, some embodiments of the present invention will be described in detail. Note that the present invention is not limited to the following embodiment.

A solid composition of the present embodiment is a solid composition containing a propylene-based polymer B and a polymer A, and satisfies the following requirements (1) to (3).
Requirement (1): the propylene-based polymer B forms a continuous phase, and the polymer A forms a dispersed phase.
Requirement (2): the polymer A has a glass transition temperature (Tg) of lower than 0° C.
Requirement (3): a crystal orientation degree of the solid composition obtained by the following formula (1) is 60 to 80%.

$$Crystal orientation degree ( \% ) = \{ ( 180 ‐ h w 0 \; 40 ) / 180 \} \times 100 \qquad Formula ( 1 )$$

[In formula (1), hw040 represents a half-value width (degree) of a maximum peak in a distribution curve of scattering intensity of a (040) plane of the propylene-based polymer B with respect to an azimuth angle, obtained from a two-dimensional wide-angle X-ray scattering image of a central portion of the solid composition.]

### Propylene-Based Polymer B

The propylene-based polymer B of the present invention is a polymer containing a propylene-derived structural unit, and can be (1) a propylene homopolymer, (2) a propylene random copolymer, or (3) a propylene multistage polymerization material (heterophasic propylene polymerization material). The propylene-based polymer B may be one of these materials, or may be a mixture of two or more of these materials. Note that, in the present specification, “structural unit” can be rephrased as “monomer unit”.

### (1) Propylene Homopolymer

The propylene homopolymer is a polymer containing only a propylene-derived structural unit.

### (2) Propylene Random Copolymer

The propylene random copolymer is
(2-1) a random copolymer containing a propylene-derived structural unit and an ethylene-derived structural unit,
(2-2) a random copolymer containing a propylene-derived structural unit and a structural unit derived from an α-olefin having 4 to 10 carbon atoms, or
(2-3) a random copolymer containing a propylene-derived structural unit, an ethylene-derived structural unit, and a structural unit derived from an α-olefin having 4 to 10 carbon atoms.

Examples of the α-olefin having 4 to 10 carbon atoms used in the random copolymer (2-2) or (2-3) include 1-butene, 1-pentene, 1-hexene, 4-methyl-1-pentene, 1-octene, and 1-decene. The α-olefin having 4 to 10 carbon atoms is preferably 1-butene, 1-hexene, or 1-octene.

Examples of the random copolymer (2-2) include a propylene-1-butene random copolymer, a propylene-1-hexene random copolymer, a propylene-1-octene random copolymer, and a propylene-1-decene random copolymer.

Examples of the random copolymer (2-3) include a propylene-ethylene-1-butene copolymer, a propylene-ethylene-1-hexene copolymer, propylene-ethylene-1-octene copolymer, and a propylene-ethylene-1-decene copolymer.

The content of the ethylene-derived structural unit contained in the random copolymer (2-1) is preferably 0.1 to 30% by weight, more preferably 0.1 to 20% by weight, and still more preferably 0.1 to 10% by weight. The content of the propylene-derived structural unit contained in the random copolymer (2-1) is preferably 99.9 to 70% by weight, more preferably 99.9 to 80% by weight, and still more preferably 99.9 to 90% by weight. (Note that the total weight of the random copolymer (2-1) is 100% by weight.)

The content of the structural unit derived from an α-olefin having 4 to 10 carbon atoms contained in the random copolymer (2-2) is preferably 0.1 to 30% by weight, more preferably 0.1 to 20% by weight, and still more preferably 0.1 to 10% by weight. The content of the propylene-derived structural unit contained in the random copolymer (2-2) is preferably 99.9 to 70% by weight, more preferably 99.9 to 80% by weight, and still more preferably 99.9 to 90% by weight. (Note that the total weight of the random copolymer (2-2) is 100% by weight.)

The total of the content of the ethylene-derived structural unit and the content of the structural unit derived from an α-olefin having 4 to 10 carbon atoms contained in the random copolymer (2-3) is preferably 0.1 to 49% by weight, more preferably 0.1 to 40% by weight, and still more preferably 0.1 to 30% by weight. The content of the propylene-derived structural unit contained in the random copolymer (2-3) is preferably 99.9 to 51% by weight, more preferably 99.9 to 60% by weight, and still more preferably 99.9 to 70% by weight. (Note that the total weight of the random copolymer (2-3) is 100% by weight.)

### (3) Propylene Multistage Polymerization Material

The propylene multistage polymerization material is
(3-1) a propylene multistage polymerization material containing the following propylene homopolymer component (I-1) and the following propylene copolymer component (II) (that is, a mixture of the propylene homopolymer component (I-1) and the propylene copolymer component (II)), or
(3-2) a propylene multistage polymerization material containing the following propylene copolymer component (I-2) and the following propylene copolymer component (II) (that is, a mixture of the propylene copolymer component (I-2) and the propylene copolymer component (II)).

Here, the propylene homopolymer component (I-1) and the propylene copolymer component (I-2) are collectively referred to as a polymer component (I).

The propylene homopolymer component (I-1) is a homopolymer component containing only a propylene-derived structural unit.

The propylene copolymer component (I-2) is a copolymer component containing a propylene-derived structural unit and a structural unit derived from an olefin selected from ethylene and an α-olefin having 4 to 10 carbon atoms, and the content of the structural unit derived from the olefin selected from ethylene and an α-olefin having 4 to 10 carbon atoms is 0.1% by weight or more and less than 208 by weight, preferably 0.1 to 15% by weight, and more preferably 0.1 to 10% by weight. (Note that the total weight of the propylene copolymer component (I-2) is 100% by weight.)

In the propylene copolymer component (I-2), the content of the propylene-derived structural unit is more than 80% by weight and 99.9% by weight or less, preferably 85 to 99.9% by weight, and more preferably 90 to 99.9% by weight.

The propylene copolymer component (II) is a copolymer component containing a propylene-derived structural unit and a structural unit derived from an olefin selected from ethylene and an α-olefin having 4 to 10 carbon atoms, and the content of the structural unit derived from the olefin selected from ethylene and an α-olefin having 4 to 10 carbon atoms is 20 to 80% by weight, preferably 20 to 60% by weight, and more preferably 30 to 60% by weight. (Note that the total weight of the propylene copolymer component (II) is 100% by weight.)

The content of the propylene-derived structural unit is 20 to 80% by weight, preferably 40 to 80% by weight, and more preferably 40 to 70% by weight.

Examples of the α-olefin having 4 to 10 carbon atoms used in the propylene copolymer component (I-2) or the propylene copolymer component (II) include 1-butene, 1-pentene, 1-hexene, 4-methyl-1-pentene, 1-octene, and 1-decene. The α-olefin having 4 to 10 carbon atoms is preferably 1-butene, 1-hexene, or 1-octene, and more preferably 1-butene.

Examples of the propylene copolymer component (I-2) include a propylene-ethylene copolymer component, a propylene-1-butene copolymer component, a propylene-1-hexene copolymer component, a propylene-1-octene copolymer component, a propylene-ethylene-1-butene copolymer component, a propylene-ethylene-1-hexene copolymer component, and a propylene-ethylene-1-octene copolymer component. The propylene copolymer component (I-2) is preferably propylene-ethylene copolymer component, a propylene-1-butene copolymer component, or a propylene-ethylene-1-butene copolymer component.

Examples of the propylene copolymer component (II) include a propylene-ethylene copolymer component, a propylene-ethylene-1-butene copolymer component, a propylene-ethylene-1-hexene copolymer component, a propylene-ethylene-1-octene copolymer component, a propylene-ethylene-1-decene copolymer component, a propylene-1-butene copolymer component, a propylene-1-hexene copolymer component, a propylene-1-octene copolymer component, and a propylene-1-decene copolymer component. The propylene copolymer component (II) is preferably a propylene-ethylene copolymer component, a propylene-1-butene copolymer component, or a propylene-ethylene-1-butene copolymer component, and more preferably a propylene-ethylene copolymer component.

Examples of the propylene multistage polymerization material (3-1) include a (propylene)-(propylene-ethylene) multistage polymerization material, a (propylene)-(propylene-ethylene-1-butene) multistage polymerization material, a (propylene)-(propylene-ethylene-1-hexene) multistage polymerization material, a (propylene)-(propylene-ethylene-1-octene) multistage polymerization material, a (propylene)-(propylene-1-butene) multistage polymerization material, a (propylene)-(propylene-1-hexene) multistage polymerization material, a (propylene)-(propylene-1-octene) multistage polymerization material, and a (propylene)-(propylene-1-decene) multistage polymerization material.

The propylene multistage polymerization material (3-1) is preferably a (propylene)-(propylene-ethylene) multistage polymerization material or a (propylene)-(propylene-ethylene-1-butene) multistage polymerization material are preferable, and more preferably a (propylene)-(propylene-ethylene) multistage polymerization material.

Examples of the propylene multistage polymerization material (3-2) include a (propylene-ethylene)-(propylene-ethylene) multistage polymerization material, a (propylene-ethylene)-(propylene-ethylene-1-butene) multistage polymerization material, a (propylene-ethylene)-(propylene-ethylene-1-hexene) multistage polymerization material, a (propylene-ethylene)-(propylene-ethylene-1-octene) multistage polymerization material, a (propylene-ethylene)-(propylene-ethylene-1-decene) multistage polymerization material, a (propylene-ethylene)-(propylene-1-butene) multistage polymerization material, a (propylene-ethylene)-(propylene-1-hexene) multistage polymerization material, a (propylene-ethylene)-(propylene-1-octene) multistage polymerization material, a (propylene-ethylene)-(propylene-1-decene) multistage polymerization material, a (propylene-1-butene)-(propylene-ethylene) multistage polymerization material, a (propylene-1-butene)-(propylene-ethylene-1-butene) multistage polymerization material, a (propylene-1-butene)-(propylene-ethylene-1-hexene) multistage polymerization material, a (propylene-1-butene)-(propylene-ethylene-1-octene) multistage polymerization material, a (propylene-1-butene)-(propylene-ethylene-1-decene) multistage polymerization material, (propylene-1-butene)-(propylene-1-butene) multistage polymerization material, a (propylene-1-butene)-(propylene-1-hexene) multistage polymerization material, a (propylene-1-butene)-(propylene-1-octene) multistage polymerization material, a (propylene-1-butene)-(propylene-1-decene) multistage polymerization material, a (propylene-1-hexene)-(propylene-1-hexene) multistage polymerization material, a (propylene-1-hexene)-(propylene-1-octene) multistage polymerization material, a (propylene-1-hexene)-(propylene-1-decene) multistage polymerization material, a (propylene-1-octene)-(propylene-1-octene) multistage polymerization material, and a (propylene-1-octene)-(propylene-1-decene) multistage polymerization material.

The propylene multistage polymerization material (3-2) is preferably a (propylene-ethylene)-(propylene-ethylene) multistage polymerization material, a (propylene-ethylene)-(propylene-ethylene-1-butene) multistage polymerization material, or a (propylene-1-butene)-(propylene-1-butene) multistage polymerization material.

The content of the copolymer component (II) contained in the multistage polymerization material containing the polymer component (I) and the copolymer component (II) is preferably 1 to 49% by weight, more preferably 1 to 40% by weight, still more preferably 1 to 30% by weight, and further still more preferably 1 to 20% by weight (note that the total weight of the multistage polymerization material is 100% by weight).

The content of the polymer component (I) contained in the multistage polymerization material containing the polymer component (I) and the copolymer component (II) is preferably 51 to 99% by weight, more preferably 60 to 99% by weight, still more preferably 70 to 99% by weight, and further still more preferably 80 to 998 by weight (note that the total weight of the multistage polymerization material is 100% by weight).

### MFR of Propylene-Based Polymer B

A melt mass flow rate (MFR) of the propylene-based polymer B measured under conditions of a temperature of 230° C. and a load of 2.16 kgf is preferably 0.01 to 20 g/10 min, more preferably 0.01 to 10 g/10 min, still more preferably 0.01 to 5 g/10 min, and may be 0.01 to 2 g/10 min. When a value of the melt mass flow rate of the propylene-based polymer B is within the above range, impact resistance of the solid composition tends to be excellent.

In the present specification, the melt mass flow rate refers to a value measured in accordance with JIS K6758.

### Tg of Propylene-Based Polymer B

A glass transition temperature (PP: Tg) of the propylene-based polymer B is preferably −30° C. or higher, more preferably −20° C. or higher, still more preferably −10° C. or higher, and further still more preferably 0° C. or higher from a viewpoint of impact resistance. Note that the Tg is measured in accordance with JIS K7121.

The glass transition temperature (PP: Tg) of the propylene-based polymer B is a value obtained by differential scanning calorimeter (DSC) measurement in accordance with JIS K7121.

### Tm of Propylene-Based Polymer B

The propylene-based polymer B can have a melting point (Tm) of 100 to 180° C. The melting point of the propylene-based polymer B is obtained by differential scanning calorimeter (DSC) measurement in accordance with JIS K7121.

### Method for Producing Propylene-Based Polymer B

The propylene-based polymer B can be obtained by homopolymerizing propylene using a polymerization catalyst or copolymerizing propylene and another olefin using a polymerization catalyst.

### Polymerization Catalyst

Examples of the polymerization catalyst include:
(1) a catalyst system containing (1-i) a solid catalyst component containing magnesium, titanium, a halogen, and an electron donor as essential components, (1-ii) an organoaluminum compound, and (1-iii) an electron donor component;
(2) a catalyst system containing (2-i) a transition metal compound of group 4 of the periodic table having a cyclopentadienyl ring and (2-ii) an alkylaluminoxane;
(3) a catalyst system containing (3-i) a transition metal compound of group 4 of the periodic table having a cyclopentadienyl ring, (3-ii) a compound that reacts with the transition metal compound (3-i) to form an ionic complex, and (3-iii) an organic aluminum compound; and
(4) a catalyst system in which a catalyst component containing (4-i) a transition metal compound of group 4 of the periodic table having a cyclopentadienyl ring, (4-ii) a compound that forms an ionic complex, (4-iii) an organic aluminum compound, and the like is carried on inorganic particles such as silica and clay minerals, and modified.

In addition, a prepolymerized catalyst prepared by prepolymerizing ethylene, propylene, or an α-olefin in the presence of the above catalyst systems may be used.

Examples of the above catalyst systems include catalyst systems described in JP-A-61-218606, JP-A-5-194685, JP-A-7-216017, JP-A-9-316147, JP-A-10-212319, and JP-A-2004-182981.

### Polymerization Method

Examples of a polymerization method include bulk polymerization, solution polymerization, slurry polymerization, and gas phase polymerization. Each of these polymerization methods may be either a batch type method or a continuous type method. In addition, each of these polymerization methods may be either a single-stage type method using a single polymerization reaction tank or a multistage type method in which a plurality of polymerization reaction tanks is connected in series, and these polymerization methods may be arbitrarily combined. For example, in a case of the propylene multistage polymerization material, the propylene homopolymer component (I-1) or the propylene copolymer component (I-2) can be polymerized in a former stage, and the propylene copolymer component (II) can be polymerized in a latter stage.

Note that various conditions (polymerization temperature, polymerization pressure, monomer concentration, catalyst input amount, polymerization time, and the like) in a polymerization step only need to be appropriately determined according to (1) a propylene homopolymer, (2) a propylene random copolymer, and (3) a propylene multistage polymerization material to be produced.

Examples of a method for producing (1) a propylene homopolymer, (2) a propylene random copolymer, and (3) a propylene multistage polymerization material include a method in which a propylene homopolymer or a copolymer of propylene and another olefin obtained using the above polymerization catalyst by the above polymerization method is subjected to an extraction operation with boiling octane to remove a component soluble in boiling octane, and as a component insoluble in boiling octane, (1) a propylene homopolymer, (2) a propylene random copolymer, (3) a propylene block copolymer, or (4) a propylene multistage polymerization material is collected.

Examples of a method for collecting a component insoluble in boiling octane include a method in which a propylene homopolymer or a copolymer of propylene and another olefin obtained by polymerization is added to a Soxhlet extraction filter paper using a Soxhlet extraction tube, and refluxed with boiling octane for five hours to extract and remove a component soluble in boiling octane from the homopolymer or the copolymer, and a component insoluble in boiling octane remaining on the Soxhlet extraction filter paper is collected.

Octane used in the extraction operation has a volume of 0.1 L per 20 g of the homopolymer or the copolymer obtained by polymerization.

### Polymer A

The polymer A is incompatible with the propylene-based polymer B.

### Tg of Polymer A

The glass transition temperature (Tg) of the polymer A is lower than 0° C. [requirement (2)], preferably −30° C. or lower, and more preferably −40° C. or lower from a viewpoint of impact resistance. The lower the glass transition temperature (Tg) is, the better the impact resistance of the solid composition tends to be.

The glass transition temperature (Tg) of the polymer A is a value obtained by differential scanning calorimeter (DSC) measurement in accordance with JIS K7121.

### MFR of Polymer A

A melt mass flow rate (MFR) of the polymer A measured under conditions of a temperature of 190° C. and a load of 2.16 kgf can be 0.01 g/10 min or more and 35 g/10 min or less. An upper limit of the MFR can be 20 g/10 min, 10 g/10 min, 5 g/10 min, 2.0 g/10 min, or 1.0 g/10 min. The smaller the melt mass flow rate of the polymer A is, the better the impact resistance of the solid composition tends to be.

### Tm of Polymer A

A melting point of the polymer A obtained by DSC is preferably lower than 200° C., more preferably lower than 180° C., and still more preferably lower than 150° C. from a viewpoint of processability.

The melting point (Tm) of the polymer A obtained by DSC is a melting temperature of a crystal phase contained in the polymer A, and is specifically a peak top temperature at the highest endothermic peak in a DSC curve obtained when the temperature of the polymer A is raised.

Note that this melting point is measured under the following conditions. (i) About 10 mg of the polymer A is heat-treated at 220° C. for five minutes in a nitrogen atmosphere, and then cooled to 50° C. at a temperature falling rate of 10° C./min. (ii) Subsequently, the polymer A is kept warm at 50° C. for one minute, and then heated from 50° C. to 180° C. at a temperature rising rate of 10° C./min.

The polymer A of the present invention is preferably a thermoplastic resin. Examples of the thermoplastic resin include an olefin-based polymer, a styrene-based polymer, a methacrylic resin, an acrylic resin, an ester-based resin, an amide-based resin, a vinyl-based polymer, and a fluorine-based resin, and the polymer A may be a single resin or a mixture of two or more resins.

### Olefin-Based Polymer

The olefin-based polymer of the present invention is a polymer containing a structural unit derived from an olefin having 2 to 10 carbon atoms except 3 carbon atoms in an amount of 51% by weight or more (note that the total amount of the olefinic polymer is 100% by weight). Examples of the olefin having 2 to 10 carbon atoms except 3 carbon atoms include ethylene, 1-butene, 4-methyl-1-pentene, 1-hexene, 1-octene, and 1-decene, and the olefin having 2 to 10 carbon atoms except 3 carbon atoms may contain any two or more of these olefins.

The olefin-based polymer may contain a structural unit derived from a monomer other than the olefin having 2 to 10 carbon atoms except 3 carbon atoms. Examples of the monomer other than the olefin having 2 to 10 carbon atoms excluding 3 carbon atoms include: an aromatic vinyl monomer such as styrene; an unsaturated carboxylic acid such as acrylic acid or methacrylic acid; an unsaturated carboxylate such as methyl acrylate, ethyl acrylate, butyl acrylate, methyl methacrylate, or ethyl methacrylate; a vinyl ester compound such as vinyl acetate; a conjugated diene such as 1,3 butadiene or 2-methyl-1,3-butadiene (isoprene); a non-conjugated diene such as dicyclopentadiene or 5-ethylidene-2-norbornene; and propylene.

The olefin-based polymer is preferably a thermoplastic elastomer, and examples thereof include an ethylene-based copolymer, a butene-based copolymer, and an octene-based copolymer.

### Ethylene-Based Copolymer

Examples of the ethylene-based copolymer include an ethylene-propylene copolymer, an ethylene-1-butene copolymer, an ethylene-propylene-1-butene copolymer, an ethylene-isobutene copolymer, an ethylene-1-pentene copolymer, an ethylene-2-methyl-1-butene copolymer, an ethylene-3-methyl-1-butene copolymer, an ethylene-1-hexene copolymer, an ethylene-2-methyl-1-pentene copolymer, an ethylene-3-1-pentene copolymer, an ethylene-1-octene copolymer, an ethylene-1-nonene copolymer, and an ethylene-1-decene copolymer. The ethylene-based copolymer is preferably an ethylene-propylene copolymer, an ethylene-1-butene copolymer, an ethylene-propylene-1-butene copolymer, or an ethylene-1-octene copolymer, more preferably an ethylene-propylene copolymer, an ethylene-1-butene copolymer, or an ethylene-1-octene copolymer, and still more preferably an ethylene-propylene copolymer or an ethylene-1-butene copolymer.

The ethylene-based copolymer may have, in addition to structural units derived from ethylene and an olefin other than ethylene, a structural unit derived from another monomer. Examples of the other monomer include: a conjugated diene having 4 to 8 carbon atoms, such as 1,3-butadiene, 2-methyl-1,3-butadiene (isoprene), 1,3-pentadiene, or 2,3-dimethyl-1,3-butadiene; a non-conjugated diene having 5 to 15 carbon atoms, such as dicyclopentadiene, 5-ethylidene-2-norbornene, 1,4-hexadiene, 1,5-dicyclooctadiene, 7-methyl-1,6-octadiene, or 5-vinyl-2-norbornene; a vinyl ester compound such as vinyl acetate; an unsaturated carboxylate such as methyl acrylate, ethyl acrylate, butyl acrylate, methyl methacrylate, or ethyl methacrylate; an unsaturated carboxylic acid such as acrylic acid or methacrylic acid; and a vinyl aromatic compound such as styrene. The other monomer is preferably 5-ethylidene-2-norbornene, dicyclopentadiene, or styrene.

The ethylene-based copolymer may be a styrene-ethylene-butylene-styrene (SEBS) block copolymer. Note that, also in SEBS, when the total amount of the polymer is 100% by weight, a structural unit derived from an olefin (ethylene and butylene) other than propylene is 51% by weight or more, and therefore a structural unit derived from styrene is 49% by weight or less.

The content of the structural unit derived from ethylene in the ethylene-based copolymer is preferably 30% by weight or more and 95% by weight or less, and more preferably 40% by weight or more and 808 by weight or less.

When the ethylene-based copolymer has, in addition to a structural unit derived from propylene or an α-olefin having 4 to 10 carbon atoms and a structural unit derived from ethylene, a structural unit derived from another monomer, the content of the structural unit derived from the other monomer is preferably 1 part by weight or more and 40 parts by weight or less, and more preferably 5 parts by weight or more and 25 parts by weight or less. Note that the total of the content of the structural unit derived from ethylene and the content of the structural unit derived from propylene or an α-olefin having 4 to 10 carbon atoms is 100 parts by weight.

The olefin-based polymer may have two or more types of structural units derived from the other monomer.

### Styrene-Based Polymer

The styrene-based polymer is a polymer containing a structural unit derived from styrene or a styrene derivative in an amount of 51% by weight or more. Examples of the styrene derivative include p-methylstyrene, p-tert-butylstyrene, α-methylstyrene, and p-methoxystyrene. The styrene-based polymer may contain a structural unit derived from a monomer other than styrene or a styrene derivative, and examples thereof include: an olefin having 2 or more and 10 or less carbon atoms; an unsaturated carboxylic acid such as acrylic acid or methacrylic acid; an unsaturated carboxylate such as methyl acrylate, ethyl acrylate, butyl acrylate, methyl methacrylate, or ethyl methacrylate; a vinyl ester compound such as vinyl acetate; a conjugated diene such as 1,3 butadiene or 2-methyl-1,3-butadiene (isoprene); and a non-conjugated diene such as dicyclopentadiene or 5-ethylidene-2-norbornene.

### Methacrylic Resin

The methacrylic resin is a polymer containing a structural unit derived from a methacrylate in an amount of 51% by weight or more, and examples thereof include poly(methyl methacrylate), poly(ethyl methacrylate), poly(butyl methacrylate), and poly(2-ethylhexyl methacrylate).

### Acrylic Resin

The acrylic resin is a polymer containing a structural unit derived from an acrylate in an amount of 51% by weight or more, and examples thereof include poly(methyl acrylate), poly(ethyl acrylate), poly(butyl acrylate), and poly(2-ethylhexyl acrylate).

### Ester-Based Resin

The ester-based resin is a polymer containing a structural unit derived from an ester of a polycarboxylic acid and a polyhydric alcohol in an amount of 51% by weight or more, and examples thereof include polyethylene terephthalate, polyethylene naphthalate, polybutylene terephthalate, and polybutylene naphthalate.

### Amide-Based Resin

The amide-based resin is a polymer containing a structural unit repeated by an amide bond in an amount of 51% by weight or more, and examples thereof include poly (ϵ-caprolactam), polydodecanamide, poly(hexamethylene adipamide), poly(hexamethylene dodecanamide), poly(p-phenylene terephthalamide), and poly(m-phenylene terephthalamide).

### Vinyl-Based Polymer

The vinyl-based polymer of the present invention is a polymer containing a structural unit derived from a monomer having a vinyl group in an amount of 51% by weight or more, and examples thereof include polyvinyl chloride, polyvinyl acetate, polyvinyl alcohol, polyvinyl acetal, and polyvinylidene chloride.

### Fluorine-Based Resin

The fluorine-based resin of the present invention is a polymer containing a structural unit containing a fluorine atom in an amount of 51% by weight or more, and examples thereof include polytetrafluoroethylene, polychlorotrifluoroethylene, polyvinylidene fluoride, polyvinyl fluoride, a perfluoroalkoxy fluorine resin, a tetrafluoroethylene-hexafluoropropylene copolymer, an ethylene-tetrafluoroethylene copolymer, an ethylene-chlorotrifluoroethylene copolymer, a perfluoroalkoxy alkane, an ethylene-tetrafluoroethylene copolymer, an ethylene-1H, 1H, 2H, 2H-tridecafluoro-1-octyl acrylate-methyl acrylate copolymer, an ethylene-2-hydroxy-3-((3,3,4,4,5,5,6,6,7 7,8,8,8-tridecafluorooctyl) amino) propyl methacrylate-glycidyl methacrylate copolymer, and an ethylene-2-hydroxy-3-((3,3,4,4,5,5,6,6,7,7,8,8,8-tridecafluorooctyl) oxy) propyl methacrylate-glycidyl methacrylate copolymer.

As a method for producing the above polymer A, a known polymerization method using a known polymerization catalyst is used.

### Composition of Solid Composition

The solid composition of the present invention contains the propylene-based polymer B and the polymer A.

As described in the above requirement (1), in the solid composition, the propylene-based polymer B forms a continuous phase, and the polymer A forms a dispersed phase. In other words, in the solid composition, the propylene-based polymer B and the polymer A are not compatible with each other, and the solid composition has a sea-island structure in which the polymer A is a continuous phase (sea portion), and the propylene-based polymer B is a dispersed phase (island portion). The dispersed phase (island portion) can have an average circle equivalent diameter of 10 nm to 200 μm.

In the solid composition, when the total of the propylene-based polymer B and the polymer A is 100 parts by weight, preferably, the propylene-based polymer B occupies 50.1 to 99.9 parts by weight and the polymer A occupies 0.1 to 49.9 parts by weight. In the solid composition, more preferably, the propylene-based polymer B occupies 70 to 99.9 parts by weight and the polymer A occupies 0.1 to 30 parts by weight, still more preferably, the propylene-based polymer B occupies 80 to 99.9% by weight and the polymer A occupies 0.1 to 20% by weight, and further still more preferably, the propylene-based polymer B occupies 90 to 99.9% by weight and the polymer A occupies 0.1 to 10% by weight.

When the amount of the polymer A is too large, a low-temperature impact property tends to decrease.

The total content of the propylene-based polymer B and the polymer A in the whole solid composition can be 50% by weight or more, preferably 60% by weight or more, and more preferably 70% by weight or more.

### Crystal Orientation Degree of Central Portion of Solid Composition (Requirement 3)

As described above in requirement (3), the crystal orientation degree of the solid composition is 60 to 80%. A lower limit of the crystal orientation degree may be 62%, 63%, or 65%. An upper limit of the crystal orientation degree may be 79%, 78%, 77%, 76%, or 75%.

When the orientation degree is too high or too low, the low-temperature impact property tends to decrease.

The crystal orientation degree of the solid composition is measured as follows. First, a two-dimensional wide-angle X-ray scattering image of a central portion of the solid composition is obtained by a wide-angle X-ray scattering (WAXS) method. Next, on the basis of the scattering image, a distribution curve of scattering intensity of a (040) plane of an α crystal of the propylene-based polymer B with respect to an azimuth angle β is obtained. When the distribution curve of the scattering intensity with respect to the azimuth angle β is obtained, a width of an annular integral at the scattering angle 2θ is within a range of ±0.5° from a scattering peak position derived from the (040) plane. Next, a half-value width hw040 (unit: degree) of a maximum peak in the distribution curve of the scattering intensity with respect to the azimuth angle β is obtained. Then, the half-value width hw040 is put into formula (1).

$$Crystal orientation degree ( \% ) = \{ ( 180 ‐ h w 0 \; 40 ) / 180 \} \times 100 \qquad ( 1 )$$

The α crystal of the propylene-based polymer B is an orthorhombic crystal of a chain (molecular chain) containing a propylene-derived structure. In the two-dimensional wide-angle X-ray scattering image, a peak of the (040) plane of the α crystal usually exists within a range of the scattering angle 2θ=16 to 18°.

The central portion of the solid composition is a portion other than a surface layer portion of the solid composition, and is any place of 5% to 95% in a thickness direction when a distance from one surface of the solid composition to the other surface (for example, a thickness from one end face to the other end face) is 100%, one surface is 0%, and the other surface is 100%. In particular, a place of 20 to 80% is preferable.

Note that in order to obtain XRD of the central portion, it is only required to obtain a cross section of the solid composition, and then to irradiate the central portion in the cross section with an X-ray.

The two-dimensional wide-angle X-ray scattering image is obtained by irradiating a sample with an X-ray from one direction. When the X-ray irradiation direction is parallel to an orientation direction of the propylene-based polymer B, a scattering peak is not obtained. Therefore, X-ray irradiation is performed in a direction intersecting (preferably orthogonal to) the orientation direction of the propylene-based polymer B, that is, in a direction intersecting (preferably orthogonal to) a direction in which the polymer flowed during pressing in a production process. When the orientation direction of the propylene-based polymer B cannot be found in a sample, it is only required to irradiate the sample with X-rays from various directions to obtain a plurality of scattering images, to obtain a distribution curve of scattering intensity derived from the (040) plane with respect to the azimuth angle on the basis of the scattering images, and to obtain hw040 on the basis of a distribution curve having the highest maximum peak.

For example, when a pressed direction (thickness direction) at the time of production can be found, preferably, an X-ray scattering image is obtained for each of three directions of a first direction orthogonal to the thickness direction, a second direction orthogonal to the thickness direction and orthogonal to the first direction, and a third direction orthogonal to the thickness direction and forming 45 degrees with the first direction, and hw040 is obtained on the basis of a distribution curve in which a maximum peak of the scattering intensity derived from the (040) plane is the highest.

The solid composition may optionally contain an additive. Examples of the additive include a stabilizer, an antimicrobial agent, an antifungal agent, a dispersant, a plasticizer, a flame retardant, a tackifier, a colorant, a metal powder, an inorganic fiber, an organic fiber, a composite fiber, an inorganic whisker, and a filler. Examples of the stabilizer include a lubricant, an anti-aging agent, a heat stabilizer, a light resistance agent, a weathering agent, a metal deactivator, an ultraviolet absorber, a light stabilizer, and a copper inhibitor. Examples of the light resistance agent include a hindered amine-based light resistance agent. Examples of the colorant include titanium oxide, carbon black, and an organic pigment. Examples of the metal powder include ferrite. Examples of the inorganic fiber include a glass fiber and a metal fiber. Examples of the organic fiber include a carbon fiber and an aramid fiber. Examples of the inorganic whisker include potassium titanate whisker. Examples of the filler include glass beads, glass balloon, glass flake, asbestos, mica, calcium carbonate, talc, silica, calcium silicate, hydrotalcite, kaolin, diatomaceous earth, graphite, pumice, ebony powder, cotton flock, cork powder, barium sulfate, fluororesin, cellulose powder, and wood powder. The solid composition may contain only one type of additive or two or more types of additives. The additive may be contained in the propylene-based polymer B, that is, in the continuous phase, may be contained in the dispersed phase of the polymer A, or may form a dispersed phase different from the polymer A.

The solid composition may contain a component having low wettability from a viewpoint of enhancing an antifouling property, a low icing property, and a snow sliding property. These components having low wettability can form a dispersed phase different from the polymer A in the continuous phase of the propylene-based polymer B.

### Mechanism of Action

Such a solid composition has improved impact resistance at a low temperature. In addition, such a solid composition can have sufficient values of impact resistance and flexural modulus at a room temperature.

### Method for Producing Solid Composition

A method for producing an solid composition according to the present embodiment includes a step of causing a solid raw material containing a thermoplastic resin and the polymer A to flow under pressure at a predetermined temperature to obtain a solid composition.

In addition, in the solid composition, the thermoplastic resin forms a continuous phase, and the polymer A forms a dispersed phase,
the above glass transition temperature (Tg) of the polymer A is lower than 0° C., and
the above crystal orientation degree in the solid composition is 60 to 80%.

The thermoplastic resin may be the above propylene-based polymer B, but may be a thermoplastic resin other than the propylene-based polymer B. Examples of the thermoplastic resin other than the propylene-based polymer B include an ethylene-based polymer, a butene-based polymer, an amide-based polymer, a methacrylic polymer, an acrylic polymer, and a styrene-based polymer.

When the thermoplastic resin does not contain the propylene-based polymer B, in calculation of the above crystal orientation degree, it is only required to obtain the half-value width (degree) of the maximum peak using a distribution curve of scattering intensity at a scattering angle 2θ′ at which the maximum peak is observed within a range of the scattering angle 2θ=16 to 18° with respect to the azimuth angle β instead of the distribution curve of the scattering intensity of the (040) plane of the α crystal of the propylene-based polymer B with respect to the azimuth angle β in the two-dimensional wide-angle X-ray scattering image. When there is a plurality of maximum peaks having the same height at different scattering angles 2θ′ within the above range of the scattering angle 2θ=16 to 18°, a peak having a larger value of the scattering angle 2θ′ is adopted to obtain a distribution curve. When the distribution curve of the scattering intensity at the scattering angle 2θ′ with respect to the azimuth angle β is obtained, a width of an annular integral is within a range of ±0.5° from 2θ′.

The solid raw material contains a thermoplastic resin such as the above propylene-based polymer B and the above polymer A. The solid raw material may be a compact of a mixture obtained by melt-kneading a thermoplastic resin such as the propylene-based polymer B and the polymer A by a known method to obtain a composition raw material, and molding the composition raw material by a known method, or may be a laminated material obtained by molding each of a thermoplastic resin such as the propylene-based polymer B and the polymer A into a film or the like by a known method, and laminating the compact of the thermoplastic resin and the compact of the polymer A. Note that, in the case of the laminated material, the compact of the thermoplastic resin and the compact of the polymer A may be melt-bonded or do not have to be melt-bonded.

The solid raw material is preferably a mixture of a thermoplastic resin and the polymer A, and preferably, a thermoplastic resin such as the propylene-based polymer B forms a continuous phase and the polymer A forms a dispersed phase.

The predetermined temperature is the melting point (° C.) of a thermoplastic resin such as the propylene-based polymer B +10° C. or lower, preferably the melting point of the thermoplastic resin +5° C. or lower, still more preferably the melting point of the thermoplastic resin or lower, and still more preferably the melting point of the thermoplastic resin −5° C. or lower from a viewpoint of processability and impact resistance.

By causing the solid raw material to flow under pressure at such a temperature, molecules of the polymer are oriented in a flowing direction. Therefore, orientation of molecules in a crystal of the propylene-based polymer B can be sufficiently improved.

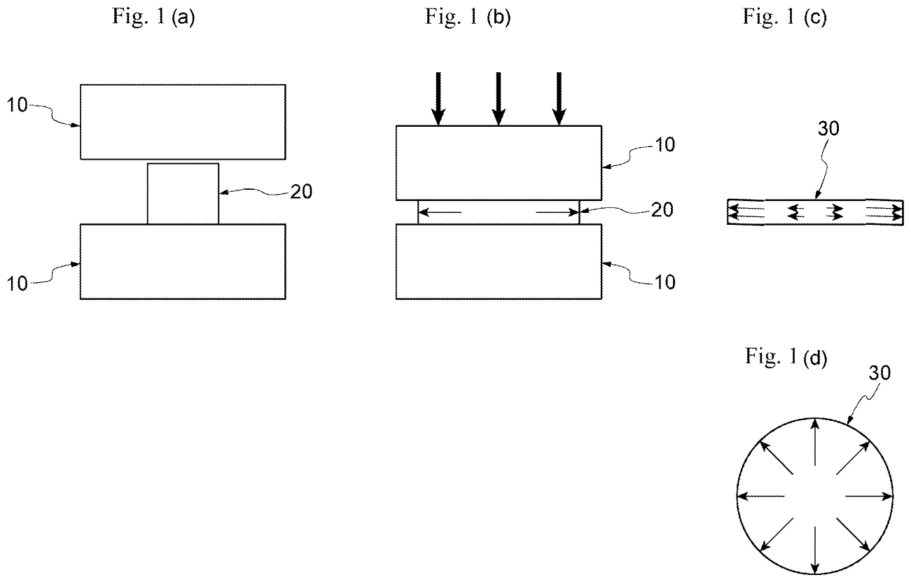

Specifically, for example, as illustrated in FIG. 1(a), by uniaxially pressurizing a solid raw material 20 in a direction of a thick arrow with a pair of, for example, plate-shaped dies 10, a polymer of the solid raw material flows in a direction intersecting the pressurizing direction (a direction of a thin arrow) as illustrated in FIG. 1(b). While a thickness decreases due to the flow, a length (width) in the direction intersecting the thickness increases. As illustrated in the side view in FIG. 1(c) and the top view in FIG. 1(d), in an obtained solid composition 30, polymer molecules of a continuous phase are oriented in a flow direction as illustrated by arrows.

In addition, also by rolling a sheet-shaped solid raw material between a pair of rolls, a polymer in the solid raw material can be caused to flow in a direction intersecting a pressing direction of the sheet.

The temperatures of the dies and the rolls are preferably set to the above predetermined temperature, but separately from these, the temperature of the solid raw material may be set to the predetermined temperature before the solid raw material is caused to flow under pressure with an infrared heater or the like.

The shape of the solid raw material is not limited, and may be a sheet shape, a disk shape, or the like.

A lubricant can be applied to portions of the dies and the rolls in contact with the solid raw material. Examples of the lubricant include silicon oil. By applying the lubricant, frictional resistance between the solid raw material and the die/roll is reduced, and the solid raw material can flow more smoothly by pressure, leading to improvement of a molding cycle and reduction of a load of an apparatus for heating compression.

The solid composition obtained by the above production method can be further molded into a required shape using a known method such as a vacuum molding method, a pneumatic molding method, or a press molding method.

The solid composition of the present invention can be bonded to another resin, metal, paper, or leather to be used as a multilayer structure.

A surface of the solid composition of the present invention may be subjected to a surface treatment. Examples of a method of the surface treatment include an embossing treatment, a corona discharge treatment, a flame treatment, a plasma treatment, and an ozone treatment.

Examples of an application of the solid composition of the present invention include an external structure member, furniture and an interior decorative member, a home electric appliance member, a toy member, a gardening member, an automobile member, and a packaging material. Examples of the external structure member include a carport member, a fence member, a gate door member, a gate pillar member, a post member, a cycle port member, a deck member, a sunroom member, a roof member, a terrace member, a handrail member, a shade member, and an awning member. Examples of the furniture and the interior decorative member include a sofa member, a table member, a chair member, a bed member, a chest member, a cabinet member, and a dresser member. Examples of the home electric appliance member include a watch member, a mobile phone member, and a white home electric appliance member. Examples of the toy member include a plastic model member, a diorama member, and a video game body member. Examples of the gardening member include a planter member, a vase member, and a flowerpot member. Examples of the automobile member include a bumper material and an instrumental panel material. Examples of the packaging material include a food packaging material, a fiber packaging material, and a general goods packaging material. Furthermore, examples of other applications include a monitor member, an office automation (OA) device member, a medical member, a drain pan, a toiletry member, a bottle, a container, a snow removing article member, and various construction members.

### EXAMPLES

Hereinafter, the present invention will be described using Examples and Comparative Examples. A propylene-based polymer B and polymers A used in Examples and Comparative Examples are described below.

### (1) Propylene-Based Polymer B

The following propylene homopolymer was obtained by controlling a hydrogen concentration in a polymerization reactor and a polymerization temperature by a gas phase polymerization method using a catalyst described in JP-A-10-2123219.

### (PP-1) Propylene Homopolymer

MFR (230° C., load: 2.16 kg): 0.5 g/10 min
Glass transition temperature (PP: Tg): 0° C.
Melting point (Tm): 163° C.

### (2) Polymer A

### (A1-1) Ethylene-Propylene Copolymer

(Trade name) TAFMER P0775: Mitsui Chemicals, Inc.
MFR (190° C., load: 2.16 kg): 0.5 g/10 min
Glass transition temperature (PP: Tg): −48° C.

### (A1-2) Ethylene-Propylene Copolymer

(Trade name) TAFMER P0275: Mitsui Chemicals, Inc.
MFR (190° C., load: 2.16 kg): 2.5 g/10 min
Glass transition temperature (PP: Tg): −47° C.
   (A2-1) Ethylene-1-butene Copolymer
(Trade name) TAFMER A0250: Mitsui Chemicals, Inc.
MFR (190° C., load: 2.16 kg): 0.2 g/10 min
Glass transition temperature (PP: Tg): −57° C.
   (A3-1) Ethylene-1-octene Copolymer
(Trade name) Engage 8100: Dow Elastomer Japan Ltd.
MFR (190° C., load: 2.16 kg): 0.5 g/10 min
Glass transition temperature (PP: Tg): −52° C.
   (A3-2) Ethylene-1-octene Copolymer
(Trade name) Engage 8200: Dow Elastomer Japan Ltd.
MFR (190° C., load: 2.16 kg): 4.9 g/10 min
Glass transition temperature (PP: Tg): −54° C.
   (A3-3) Ethylene-1-octene Copolymer
(Trade name) Engage 8407: Dow Elastomer Japan Ltd.
MFR (190° C., load: 2.16 kg): 34 g/10 min
Glass transition temperature (PP: Tg): −53° C.
   (A4-1) Styrene-ethylene-1-butene-styrene Copolymer
(Trade name) Tuftec H1062: Asahi Kasei Corporation
MFR (190° C., load: 2.16 kg): 1 g/10 min
Glass transition temperature (PP: Tg): −47° C.

### (A5-1) Ethylene-Methyl Methacrylate Copolymer

(Trade name) Acryft WH102: Sumitomo Chemical Co., Ltd.
MFR (190° C., load: 2.16 kg): 0.25 g/10 min
Glass transition temperature (PP: Tg): −40° C.

### (A6-1) Polyvinylidene Fluoride

(Trade name) KF Polymer #1300: Kureha Corporation
MFR (190° C., load: 2.16 kg): 0.19 g/10 min
Glass transition temperature (PP: Tg): −31° C.

Physical properties of a raw material component and a solid composition were measured according to the methods described below.

(1) Melt Mass Flow Rate (MFR) (Unit: g/10 min)

A melt flow rate was measured in accordance with the method specified in JIS K6758. Measurement was performed at a measurement temperature of 230° C. or 190° C. and a load of 2.16 kg.

### (2) Glass Transition Temperature (Tg, Unit: ° C.)

A glass transition temperature was measured in accordance with the method specified in JIS K7121. The measurement was performed at a measurement temperature of −60° C. to 250° C. and a temperature rising rate of 10° C./min.

### (3) Wide-Angle X-Ray Scattering (WAXS)

Wide-angle X-ray scattering at a central portion of a solid composition was measured under the following conditions.

### Measurement Conditions

Model: UltraX18 manufactured by Rigaku Corporation
X-ray source: CuKα ray
Voltage: 40 kV
Current: 200 mA
Detector: X-ray photon-counting type two-dimensional detector PILATUS
Measurement method: transmission method

### Measurement Method

A solid composition was cut in parallel to both a direction (thickness direction) in which a pressure was applied to the solid composition at the time of production and a direction (flow direction) which is orthogonal to the thickness direction and in which a resin flowed by the pressure to form a cut surface. A wide-angle X-ray scattering profile was measured by irradiating a depth position at an equal distance from both surfaces of the solid composition in the thickness direction in the cut surface with an X-ray. That is, measurement was performed at measurement points located at 50% in the thickness direction when the thickness of the solid composition was taken as 100%.

(4) Crystal Orientation Degree (unit: %)

On the basis of the obtained wide-angle X-ray scattering (WAXS) profile, an intensity distribution curve of a (040) plane of an α crystal of polypropylene with respect to an azimuth angle was obtained, a half-value width hw040 of a maximum peak was obtained, and calculation was performed by formula (1).

$$Crystal orientation degree ( \% ) = \{ ( 180 ‐ h w 0 \; 40 ) / 180 \} \times 100 \qquad formula ( 1 )$$

### (5) Normal Temperature Charpy Impact Strength (Unit: KJ/m²)

A test piece having a size of 10 mm in width and 80 mm in length was cut out from the solid composition and used for a measurement. Normal temperature Charpy impact strength was measured at a temperature of 23° C. in accordance with JIS K7111-1 (ISO0179-1).

(6) Low Temperature Charpy Impact Strength (Unit: kJ/m²)

A test piece having a size of 10 mm in width and 80 mm in length was cut out from the solid composition and used for a measurement. Low temperature Charpy impact strength was measured at a temperature of −30° C. in accordance with JIS K7111-1 (ISO0179-1).

### (7) Flexural Modulus (Unit: MPa)

A test piece having a size of 10 mm in width and 80 mm in length was cut out from the solid composition and used for a measurement. Flexural modulus at 23° C. was measured in accordance with JIS-K-7171.

### Example 1

### Preparation of Solid Raw Material

99% by weight of the propylene polymer (PP-1) and 1% by weight of the polymer (A1-1) were uniformly mixed in advance, and melt-kneaded using a 40 mmφ single screw extruder (VS40-28 model, manufactured by Tanabe Plastics Machinery Co., Ltd., with full flight screw) under conditions of a cylinder set temperature of 220° C. and a screw rotation speed of 105 rpm to obtain a composition raw material. The composition raw material was molded under conditions of a cylinder set temperature of 220° C., an injection speed of 31 mm/sec, a thickness of 11 mm, a length of 150 mm, and a width of 150 mm using a 220 ton injection molding machine (IS220EN, manufactured by Toshiba Machine Co., Ltd.) to obtain a solid raw material.

### Preparation of Solid Composition

The solid raw material was put in a hot press molding machine in which a temperature of a press plate was set to 160° C., and was pressurized up to 100 t in the thickness direction to be caused to flow in a direction orthogonal to the thickness direction. The pressure was held for five minutes. The solid raw material was cooled to 80° C. while the pressure was maintained and then depressurized to obtain a solid composition having a thickness of 4 mm. Physical properties of the obtained solid composition are presented in Table 1.

### Example 2

A solid composition was prepared by a similar method to Example 1 except that 95% by weight of the propylene polymer (PP-1) and 5% by weight of the polymer (A1-1) were used. Physical properties of the obtained solid composition are presented in Table 1.

### Example 3

A solid composition was prepared by a similar method to Example 1 except that 90% by weight of the propylene polymer (PP-1) and 10% by weight of the polymer (A1-1) were used. Physical properties of the obtained solid composition are presented in Table 1.

### Example 4

A solid composition was prepared by a similar method to Example 1 except that 958 by weight of the propylene polymer (PP-1) and 5% by weight of the polymer (A1-2) were used. Physical properties of the obtained solid composition are presented in Table 1.

### Example 5

A solid composition was prepared by a similar method to Example 1 except that 95% by weight of the propylene polymer (PP-1) and 58 by weight of the polymer (A2-1) were used. Physical properties of the obtained solid composition are presented in Table 1.

### Example 6

A solid composition was prepared by a similar method to Example 1 except that 95% by weight of the propylene polymer (PP-1) and 5% by weight of the polymer (A3-1) were used. Physical properties of the obtained solid composition are presented in Table 1.

### Example 7

A solid composition was prepared by a similar method to Example 1 except that 95% by weight of the propylene polymer (PP-1) and 5% by weight of the polymer (A3-2) were used. Physical properties of the obtained solid composition are presented in Table 1.

### Example 8

A solid composition was prepared by a similar method to Example 1 except that 95% by weight of the propylene polymer (PP-1) and 5% by weight of the polymer (A3-3) were used. Physical properties of the obtained solid composition are presented in Table 1.

### Example 9

A solid composition was prepared by a similar method to Example 1 except that 95% by weight of the propylene polymer (PP-1) and 5% by weight of the polymer (A4-1) were used. Physical properties of the obtained solid composition are presented in Table 1.

### Example 10

A solid composition was prepared by a similar method to Example 1 except that 95% by weight of the propylene polymer (PP-1) and 5% by weight of the polymer (A5-1) were used. Physical properties of the obtained solid composition are presented in Table 1.

### Comparative Example 1

### Preparation of Solid Raw Material

95% by weight of the propylene polymer (PP-1) and 5% by weight of the polymer (A1-2) were uniformly mixed in advance, and melt-kneaded using a 40 mmφ single screw extruder (VS40-28 model, manufactured by Tanabe Plastics Machinery Co., Ltd., with full flight screw) under conditions of a cylinder set temperature of 220° C. and a screw rotation speed of 105 rpm to obtain a composition raw material. The composition raw material was molded under conditions of a cylinder set temperature of 220° C., an injection speed of 31 mm/sec, a thickness of 20 mm, a length of 98 mm, and a width of 98 mm using a 150 ton injection molding machine (J150EV-C5, manufactured by The Japan Steel Works, Ltd.) to obtain a solid raw material.

### Preparation of Solid Composition

The solid raw material was put in a hot press molding machine in which a temperature of a press plate was set to 160° C., and was pressurized up to 100 t in the thickness direction to be caused to flow in a direction orthogonal to the thickness direction. The pressure was held for five minutes. The solid raw material was cooled to 80° C. while the pressure was maintained and then depressurized to obtain a solid composition having a thickness of 4 mm. Physical properties of the obtained solid composition are presented in Table 2.

### Comparative Example 2

A solid composition was prepared by a similar method to Comparative Example 1 except that only the propylene polymer (PP-1) was used and the polymer (A1-2) was not used. Physical properties of the obtained solid composition are presented in Table 2.

### Comparative Example 3

A solid composition was prepared by a similar method to Example 4 except that the thickness of the solid raw material was set to 4.8 mm. Physical properties of the obtained solid composition are presented in Table 2.

### Example 11

A solid composition was prepared by a similar method to Example 1 except that 99% by weight of the propylene polymer (PP-1) and 1% by weight of the polymer (A6-1) were used. Physical properties of the obtained solid composition are presented in Table 1.

### Example 12

A solid composition was prepared by a similar method to Example 1 except that 95% by weight of the propylene polymer (PP-1) and 5% by weight of the polymer (A6-1) were used. Physical properties of the obtained solid composition are presented in Table 1.

### Example 13

A solid composition was prepared by a similar method to Example 1 except that 98% by weight of the propylene polymer (PP-1), 1% by weight of the polymer (A1-1), and 1% by weight of the polymer (A6-1) were used. Physical properties of the obtained solid composition are presented in Table 1.

TABLE 1

| | Solid composition | | | | | | | Physical properties | | |
|---|---|---|---|---|---|---|---|---|---|---|
| | Propylene-based polymer B | | | | | | | Charpy impact | | Flexural |
| | | | Crystal | | | | | strength | | modulus |
| | | | orienta- | Polymer A | | | | Normal | Low | Normal |
| | | Composi- | tion | | | MFR | Composi- | temper- | temper- | temper- |
| | | tion | degree | | Tg | (g/10 | tion | ature | ature | ature |
| | Type | (wt %) | (%) | Type | (° C.) | min) | (wt %) | (J/cm²) | (J/cm²) | (MPa) |
| Example 1 | PP-I | 99 | 76.0 | A1-1: Ethylene-propylene copolymer (EPR) | −48 | 0.5 | 1 | 95.1 | 94.9 | 2220 |
| Example 2 | PP-I | 95 | 67.1 | A1-1: Ethylene-propylene copolymer (EPR) | −48 | 0.5 | 5 | 116.5 | 61.3 | 1764 |
| Example 3 | PP-I | 90 | 69.1 | A1-1: Ethylene-propylene copolymer (EPR) | −48 | 0.5 | 10 | 142.2 | 56.2 | 1429 |
| Example 4 | PP-I | 95 | 66.9 | A1-2: Ethylene-propylene copolymer (EPR) | −47 | 2.5 | 5 | 123.4 | 63.5 | 1748 |
| Example 5 | PP-I | 95 | 65.8 | A2-1: Ethylene-1-butene copolymer (EBR) | −57 | 0.2 | 5 | 124.2 | 61.8 | 1748 |
| Example 6 | PP-I | 95 | 61.6 | A3-1: Ethylene-1-octene copolymer (EOR) | −52 | 0.5 | 5 | 123.3 | 56 | 1950 |
| Example 7 | PP-I | 95 | 60.5 | A3-2: Ethylene-1-octene copolymer (EOR) | −54 | 4.9 | 5 | 134.3 | 58.9 | 1931 |
| Example 8 | PP-I | 95 | 60.2 | A3-3: Ethylene-1-octene copolymer (EOR) | −53 | 34 | 5 | 134.3 | 47.1 | 1653 |
| Example 9 | PP-I | 95 | 61.1 | A4-1: Styrene-ethylene-1-butene-styrene | −47 | 1 | 5 | 132.8 | 43.7 | 1716 |
| | | | | copolymer (SEBS) | | | | | | |
| Example 10 | PP-I | 95 | 65.6 | A5-1: Ethylene-methyl methacrylate | −40 | 0.25 | 5 | 116.7 | 49.8 | 1814 |
| | | | | copolymer (EMMA) | | | | | | |
| Example 11 | PP-I | 99 | 75.0 | A6-1: Polyvinylidene fluoride (PVDF) | −31 | 0.19 | 1 | 92 | 38.2 | 3169 |
| Example 12 | PP-I | 95 | 74.2 | A6-1: Polyvinylidene fluoride (PVDF) | −31 | 0.19 | 5 | 57 | 33.6 | 3368 |
| Example 13 | PP-I | 98 | 69.3 | A1-1: Ethylene-propylene copolymer (EPR) | −48 | 0.5 | 1 | 94 | 56.1 | 3050 |
| | | | | A6-1: Polyvinylidene fluoride (PVDF) | −31 | 0.19 | 1 | | | |

TABLE 2

| | Solid composition | | | | | | | Physical properties | | |
|---|---|---|---|---|---|---|---|---|---|---|
| | Propylene-based polymer B | | | | | | | Charpy impact | | Flexural |
| | | | Crystal | | | | | strength | | modulus |
| | | | orienta- | Polymer A | | | | Normal | Low | Normal |
| | | Composi- | tion | | | MFR | Composi- | temper- | temper- | temper- |
| | | tion | degree | | Tg | (g/10 | tion | ature | ature | ature |
| | Type | (wt %) | (%) | Type | (° C.) | min) | (wt %) | (J/cm²) | (J/cm²) | (MPa) |
| Comparative | PP-I | 95 | 81.2 | A1-2: Ethylene-propylene copolymer (EPR) | −47 | 2.5 | 5 | 89.5 | 27.5 | 2032 |
| Example 1 | | | | | | | | | | |
| Comparative | PP-I | 100 | 80.7 | — | — | — | — | 68 | 21.1 | 2578 |
| Example 2 | | | | | | | | | | |
| Comparative | PP-I | 95 | 53.8 | A1-2: Ethylene-propylene copolymer (EPR) | −47 | 2.5 | 5 | 23.8 | 1.7 | 2032 |
| Example 3 | | | | | | | | | | |

The solid compositions according to Examples were confirmed to have high impact resistance particularly at a low temperature. In addition, the solid compositions according to Examples also maintain impact resistance and flexural modulus at a normal temperature sufficiently highly. In addition, it was confirmed from a transmission electron micrograph that the polymer A was dispersed in the continuous layer of the propylene-based polymer B in Examples and Comparative Examples. The dispersed phase had an average circle equivalent diameter of about 0.2 to 14 μm.

### DESCRIPTION OF REFERENCE SIGNS

10 Mold

20 Solid raw material

30 Solid composition

1. A solid composition comprising a propylene-based polymer B and a polymer A, wherein
the solid composition satisfies the following requirements (1) to (3):
requirement (1): the propylene-based polymer B forms a continuous phase, and the polymer A forms a dispersed phase,
requirement (2): the polymer A has a glass transition temperature (Tg) of lower than 0° C., and
requirement (3): a crystal orientation degree of the solid composition represented by the following formula is 60 to 80%.
$$crystal orientation degree ( \% ) = \{ ( 180 ‐ h w 0 \; 40 ) / 180 \} \times 100 \qquad ( 1 )$$
[In formula (1), hw040 represents a half-value width (degree) of a maximum peak in a distribution curve of scattering intensity of a (040) plane of an α crystal of the propylene-based polymer B with respect to an azimuth angle, obtained from a two-dimensional wide-angle X-ray scattering image of a central portion of the solid composition.]

2. The solid composition according to claim 1, wherein when a total of the propylene-based polymer B and the polymer A is 100 parts by weight, the propylene-based polymer B occupies 50.1 to 99.9 parts by weight, and the polymer A occupies 0.1 to 49.9 parts by weight.

3. The solid composition according to claim 1, wherein the polymer A has a glass transition temperature (Tg) of −30° C. or lower.

4. The solid composition according to claim 1, wherein the polymer A is an ethylene-based copolymer.

5. The solid composition according to claim 4, wherein the ethylene-based copolymer is at least one selected from the group consisting of an ethylene-propylene copolymer, an ethylene-1-butene copolymer, and an ethylene-1-octene copolymer.

6. The solid composition according to claim 1, wherein the polymer A has a melt mass flow rate of 0.01 to 35 g/10 min under conditions of a temperature of 190° C. and a load of 2.16 kgf.

7. A method for producing a solid composition, comprising a step of causing a solid raw material containing a thermoplastic resin and a polymer A to flow under pressure at a temperature of a melting point (° C.) of the thermoplastic resin +10° C. or lower to obtain a solid composition, wherein
in the solid composition, the thermoplastic resin forms a continuous phase and the polymer A forms a dispersed phase,
the polymer A has a glass transition temperature (Tg) of lower than 0° C., and
a crystal orientation degree represented by the following formula in the solid composition is 60 to 80%.
$$crystal orientation degree ( \% ) = \{ ( 180 ‐ h w 0 \; 40 ) / 180 \} \times 100 \qquad ( 1 )$$
[In formula (1), hw040 represents a half-value width (degree) of a maximum peak in a distribution curve of scattering intensity at a scattering angle 2θ′ with respect to an azimuth angle β, obtained from a two-dimensional wide-angle X-ray scattering image of a central portion of the solid composition, and the scattering angle 2θ′ is an angle that gives a maximum peak within a range of a scattering angle 2θ=16° to 18°.]
